(19) United States
(12) Patent Application Publication
(10) Pub. No.: US 2019/0073462 A1
(43) Pub. Date: Mar. 7, 2019

(54) METHODS FOR AUTHENTICATING A USER, INPUT DEVICES, AND COMPUTER-READABLE MEDIA

(71) Applicant: Mastercard International Incorporated, Purchase, NY (US)

(72) Inventor: Rajat MAHESHWARI, SG (SG)

(73) Assignee: Mastercard International Incorporated, Puchase, NY (US)

(21) Appl. No.: 16/121,896

(22) Filed: Sep. 5, 2018

(30) Foreign Application Priority Data
Sep. 5, 2017 (SG) 10201707194T

(51) Int. Cl. G06F 21/32

(52) U.S. Cl. CPC G06F 21/32

(57) ABSTRACT

According to various embodiments, a method for authenticating a user may be provided. The method may include: receiving fingerprint information of the user from an input device; determining device information related to the input device; determining template information based on the device information; and performing authentication of the user based on the fingerprint information and based on the template information.

### CROSS-REFERENCE TO RELATED APPLICATIONS

This application claims priority to Singapore Patent Application No. 10201707194T filed on 5 Sep. 2017, which is hereby incorporated by reference in its entirety.

### FIELD OF INVENTION

The present invention relates broadly, but not exclusively, to methods for authenticating a user, input devices, and computer-readable media.

### BACKGROUND

Authorization and authentication may be carried out based on fingerprints of a user. However, different devices may use different data and different methods for authorization and authentication. As such, there may be a lack of interoperability between different devices.

A need therefore exists to provide methods and/or systems to address the above problem.

### SUMMARY

According to various embodiments, a method for authenticating a user may be provided. The method may include: receiving fingerprint information of the user from an input device; determining device information related to the input device; determining template information based on the device information; and performing authentication of the user based on the fingerprint information and based on the template information.

According to various embodiments, an input device may be provided. The input device may include: a fingerprint information circuit configured to provide fingerprint information of a user; a device information determination circuit configured to determine device information related to the input device; a template information determination circuit configured to determine template information based on the device information; and an authentication circuit configured to perform authentication of the user based on the fingerprint information and based on the template information.

According to various embodiments, a non-transitory computer readable medium may be provided. The non-transitory computer readable medium may include instructions, which, when executed by a processor, make the processor perform a method for authenticating a user. The method may include: receiving fingerprint information of the user from an input device; determining device information related to the input device; determining template information based on the device information; and performing authentication of the user based on the fingerprint information and based on the template information.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1A shows a flow diagram illustrating a method for authenticating a user according to various embodiments.

FIG. 1B shows an input device according to various embodiments.

FIG. 1C shows an input device according to various embodiments.

FIG. 2 shows a flow diagram illustrating a fingerprint matching process according to various embodiments.

FIG. 3 shows a verification step approach according to various embodiments.

FIG. 4 shows an exemplary computing device according to various embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a conventional computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Various embodiments are related to biometric devices, fingerprint cards, and/or fraud (for example prevention of fraud).

According to various embodiments, a payment instrument with dynamic biometric template matching may be provided.

Fingerprint authentication may involve a finger sensor, a feature extraction method, and a matching method.

A finger sensor may be a touch sensor (for example a touch finger sensor) or a swipe sensor (for example a swipe finger sensor). A touch sensor may capture the full picture of the fingerprint. A swipe sensor may capture sub-images of what will be the fingerprint.

For swipe sensors, an image composition method may join (or combine) multiple sub-images into a single composite image.

A feature extraction method may create a fingerprint template (which may also be referred to as a template).

A matching algorithm may compare the fingerprint template against an enrolment template, which may be created at the time of enrolling (in other words: signing up) a user.

The matching of a template may be done locally on a payment instrument, or on a payment acceptance device or on a server.

With commonly used devices and methods, an enrolment template which is generated using an “A” device (for example a device of a first type), may not be used for verification using a “B” device (for example a device of a second type which is different from the first type), due to different fingerprint processing methods (template generation algorithms and/or matching algorithms) implemented on device “A” and device “B”. Such cases may be common in case the matching is done on a payment acceptance device or a server.

According to various embodiments, interoperability among templates (for example templates taken from different devices (using different or similar or identical feature extraction methods) may be provided. Different devices may differ in software (for example in a matching method used, or for example in firmware), and/or in hardware (for example a type of fingerprint sensor, or for example in a coating of the fingerprint sensor). For example, the same finger imprint of same person taken on different devices, like different smartphones for example, may result in different templates. The template generated may be dependent on various factors like fingerprint sensor hardware, fingerprint sensor software, a coating of the sensor, a size of the sensor, and/or a shape of the sensor, for example.

According to various embodiments, gray scale distribution characteristics of the sensor used for enrollment may be received.

According to various embodiments, templates may be stored with a unique sensor ID. The sensor ID may be exchanged during the initiation of transaction so that the payment device, for example card device or any other contactless device, such as a fob, or a wearable device such as a ring or wristband or watch, is aware of which template to be sent for matching on terminal.

According to various embodiments, the templates may be updated on the card device by the issuer as they receive the request from acquirers.

Devices and methods according to various embodiments may dynamically use the templates for matching of a fingerprint. The templates may be stored inside the card using a database (for example a lookup table).

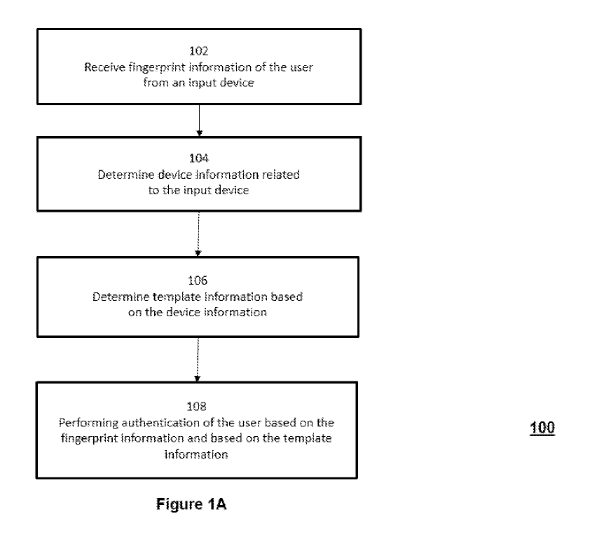

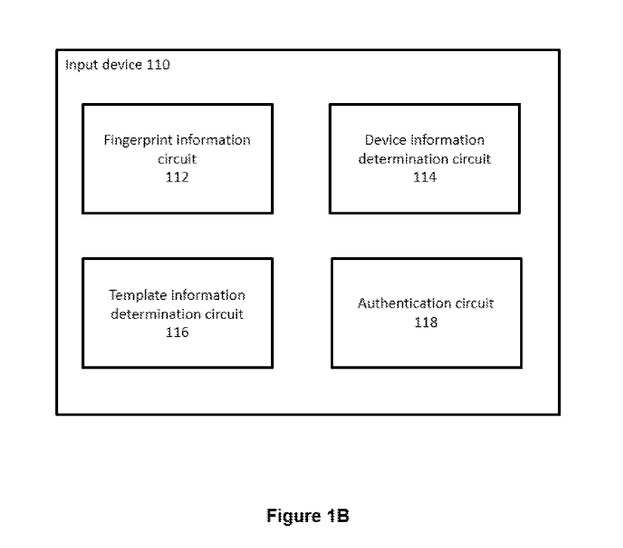

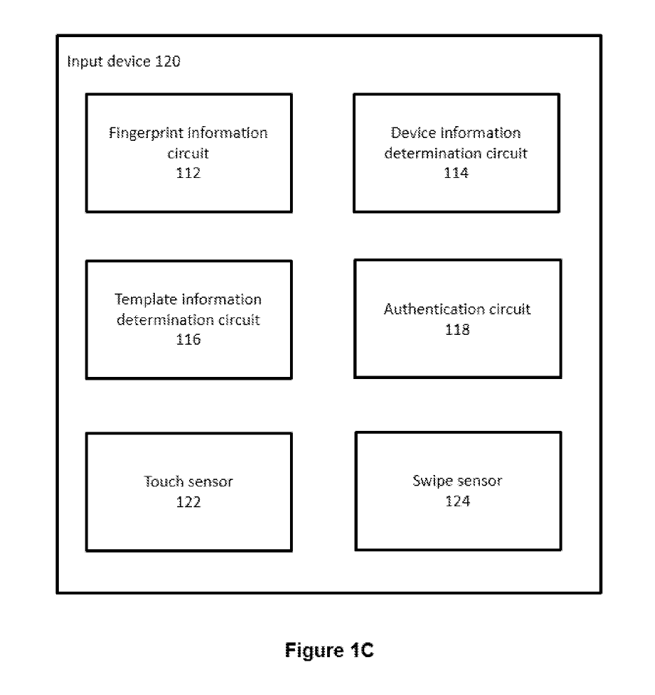

FIG. 1A shows a flow diagram 100 illustrating a method for authenticating a user. In 102, fingerprint information of the user may be received from an input device. In 104, device information related to the input device may be determined. In 106, template information may be determined based on the device information. In 108, authentication of the user may be performed based on the fingerprint information and based on the template information.

According to various embodiments, determining the template information may include determining the template information from a database based on the device information (for example based on a lookup table).

According to various embodiments, determining the template information may include determining a filter based on the device information and applying the filter to a pre-determined master template to obtain the template information. This may provide for converting a template generated using a first device to be usable with a second device. For example, a high resolution fingerprint image of a user may be provided, and if the grayscale range, pixel dimension and effective image pixel resolution of the fingerprint sensor are known, the high resolution image may be transposed into an image which is similar to what could have been received by scanning from the sensor.

According to various embodiments, the device information may include, or may be included in, an identifier of the input device.

According to various embodiments, the device information may include, or may be included in, an average gray level of information acquired by the input device.

According to various embodiments, the input device may include, or may be included in, a touch sensor.

According to various embodiments, the input device may include, or may be included in, a swipe sensor.

According to various embodiments, performing the authentication of the user may include, or may be included in, determining processing instructions based on the device information and applying the processing instructions to the template information.

According to various embodiments, a request for a personal identification number may be issued responsive to rejection of authorization. According to various embodiments, a new template may be stored responsive to receiving a correct personal identification number.

FIG. 1B illustrates an input device 110 according to various embodiments. The input device 110 may include a fingerprint information circuit 112 configured to provide fingerprint information of a user. The input device 110 may further include a device information determination circuit 114 configured to determine device information related to the input device 110. The input device 110 may further include a template information determination circuit 116 configured to determine template information based on the device information. The input device 110 may further include an authentication circuit 118 configured to perform authentication of the user based on the fingerprint information and based on the template information.

According to various embodiments, the template information determination circuit 116 may be configured to determine the template information from a database based on the device information.

According to various embodiments, the template information determination circuit 116 may be configured to determine a filter based on the device information and applying the filter to a pre-determined master template to obtain the template information.

According to various embodiments, the device information may include, or may be included in, an identifier of the input device 110.

According to various embodiments, the device information may include, or may be included, in an average gray level of information acquired by the input device 110.

According to various embodiments, the authentication circuit 118 may be configured to determine processing instructions based on the device information and applying the processing instructions to the template information.

According to various embodiments, the input device 120 may be configured to issue a request for a personal identification number if authorization is rejected.

According to various embodiments, wherein the input device 120 may be configured to store a new template, if a correct personal identification number is received.

FIG. 1C illustrates an input device 120 according to various embodiments. The input device 120 may, similar to the input device 110 illustrated in FIG. 1B, include a fingerprint information circuit 112 configured to provide fingerprint information of a user. The input device 120 may, similar to the input device 110 illustrated in FIG. 1B, further include a device information determination circuit 114 configured to determine device information related to the input device 110. The input device 120 may, similar to the input device 110 illustrated in FIG. 1B, further include a template information determination circuit 116 configured to determine template information based on the device information. The input device 120 may, similar to the input device 110 illustrated in FIG. 1B, further include an authentication circuit 118 configured to perform authentication of the user based on the fingerprint information and based on the template information. The input device 120 may further include a touch sensor 122 and/or a swipe sensor 124.

According to various embodiments, a non-transitory computer readable medium may be provided. The non-transitory computer readable medium may include instructions, which, when executed by a processor, make the processor perform a method for authenticating a user. The method may include: receiving fingerprint information of the user from an input device; determining device information related to the input device; determining template information based on the device information; and performing authentication of the user based on the fingerprint information and based on the template information.

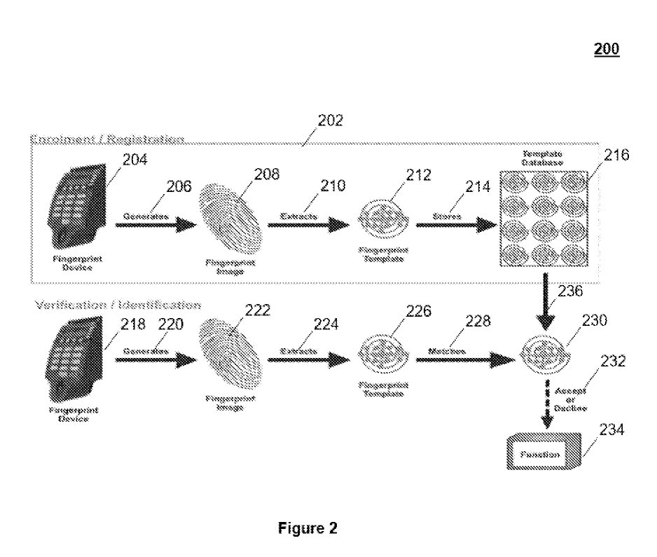

FIG. 2 shows a flow diagram 200 illustrating a fingerprint matching process according to various embodiments. The devices and method steps illustrated in box 202 pertain to enrolment (in other words: registration), while the other devices and methods pertain to verification and/or identification. A fingerprint device 204 may generate (illustrated at arrow 206) a fingerprint image 208, from which a fingerprint template 212 may be extracted (illustrated at arrow 210). The fingerprint template 212 may be stored (illustrated at arrow 214) in a template database 216.

For verification and/or identification, a fingerprint device 218 (which may be identical to or different from the fingerprint device 204) may generate (illustrated at arrow 220) a fingerprint image 222, from which a fingerprint template 226 may be extracted (illustrated at arrow 224). The fingerprint template 226 may be matched (illustrated at arrow 228) against a template extracted (illustrated at arrow 236) from the template database 216. Based on the matching (illustrated at 230), a function 234 may be accepted or declined (illustrated at arrow 232).

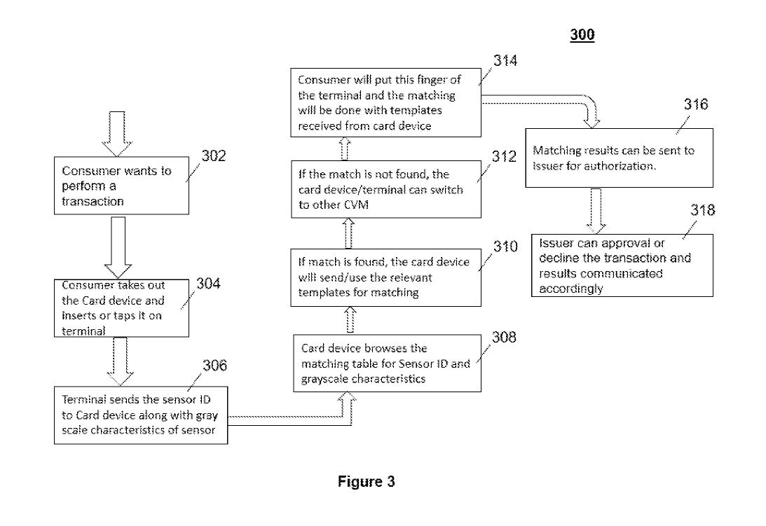

FIG. 3 shows a flow diagram 300 illustrating a verification method according to various embodiments. In 302, a consumer may desire to perform a transaction. In 304, the consumer may take out the card device and insert it on (or into) the terminal. In 306, the terminal may send the sensor ID to the card device along with gray scale characteristics of sensor. It will be understood that the same sensor hardware may behave differently depending on the coating, shape and size of the sensor used on the device. Grayscale characteristics according to various embodiments may include effective image pixel resolution, grayscale range and pixel dimensions. In 308, the card device browses the matching table for sensor ID and grayscale characteristics. In 310, if a match is found, the card device may send/use the relevant templates for matching. In 312, if a match is not found, the card device/terminal may switch to other CVM (card verification method). In 314, the consumer may put this finger of the terminal and the matching may be done with templates received from card device. In 316, matching results may be sent to Issuer for authorization. In 318, the issuer may approve or decline the transaction and the result may be communicated accordingly.

Various embodiments may be used in (or with) a biometric card, or any other contactless device, such as a fob, or a wearable device such as a ring or wristband or watch.

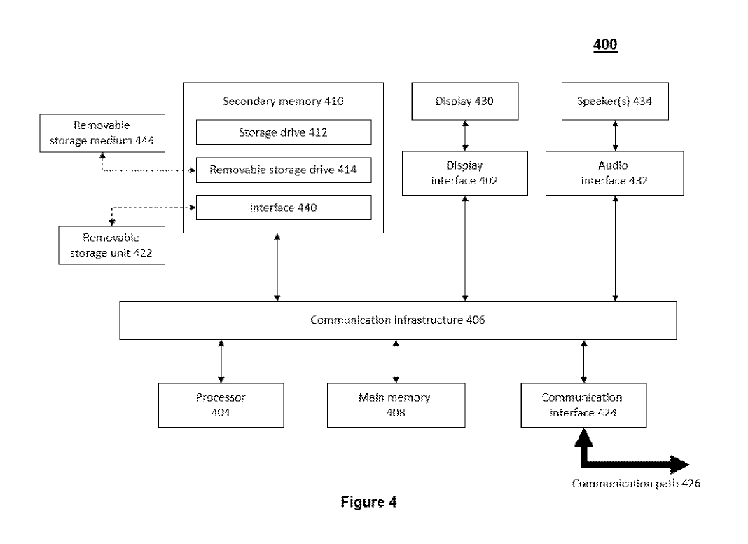

FIG. 4 depicts an exemplary computing device 400, hereinafter interchangeably referred to as a computer system 400 or as a server 400, where one or more such computing devices 400 may be used to implement the input device 110 shown in FIG. 1B or the input device 120 shown in FIG. 1C. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” (or computer readable medium, which may be a non-transitory computer readable medium) may refer, in part, to removable storage medium 444, removable storage unit 422, a hard disk installed in storage drive 412, or a carrier wave carrying software over communication path 426 (wireless link or cable) to communication interface 424. Computer readable storage media (or computer readable media) refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 450. The computer program product may be a non-transitory computer readable medium. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts. The main memory 408 and/or the secondary memory 410 may serve(s) as the memory for the input device 110 (or 120); while the processor 404 may serve as the processor of the input device 110 (or 120).

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, a “circuit” may be understood as any kind of a logic implementing entity, which may be special purpose circuitry or a processor executing software stored in a memory, firmware, or any combination thereof Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

It will be understood that any embodiment described for a card may analogously be provided for any other contactless device, such as a fob, or a wearable device such as a ring or wristband or watch.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An input device comprising:
a fingerprint information circuit configured to provide fingerprint information of a user;
a device information determination circuit configured to determine device information related to the input device;
a template information determination circuit configured to determine template information based on the device information; and
an authentication circuit configured to perform authentication of the user based on the fingerprint information and based on the template information.

2. The input device of claim 1,
wherein the template information determination circuit is configured to determine the template information from a database based on the device information.

3. The input device of claim 1,
wherein the template information determination circuit is configured to determining a filter based on the device information and applying the filter to a pre-determined master template to obtain the template information.

4. The input device of claim 1,
wherein the device information comprises an identifier of the input device.

5. The input device of claim 1,
wherein the device information comprises an average gray level of information acquired by the input device.

6. The input device of claim 1, further comprising:
a touch sensor.

7. The input device of claim 1, further comprising:
a swipe sensor.

8. The input device of claim 1,
wherein the authentication circuit configured to determine processing instructions based on the device information and applying the processing instructions to the template information.

9. The input device of claim 1,
wherein the input device is configured to issue a request for a personal identification number if authorization is rejected.

10. The input device of claim 9,
wherein the input device is configured to store a new template, if a correct personal identification number is received.

11. A method for authenticating a user, the method comprising:
receiving fingerprint information of the user from an input device;
determining device information related to the input device;
determining template information based on the device information; and
performing authentication of the user based on the fingerprint information and based on the template information.

12. The method of claim 11,
wherein determining the template information comprises determining the template information from a database based on the device information.

13. The method of claim 11,
wherein determining the template information comprises determining a filter based on the device information and applying the filter to a pre-determined master template to obtain the template information.

14. The method of claim 11,
wherein the device information comprises an identifier of the input device.

15. The method of claim 11,
wherein the device information comprises an average gray level of information acquired by the input device.

16. The method of claim 11,
wherein performing the authentication of the user comprises determining processing instructions based on the device information and applying the processing instructions to the template information.

17. The method of claim 11,
wherein a request for a personal identification number is issued responsive to rejection of authorization; and
wherein, a new template is stored responsive to receiving a correct personal identification number.

18. A non-transitory computer readable medium comprising instructions, which, when executed by a processor, make the processor perform a method for authenticating a user, the method comprising:
receiving fingerprint information of the user from an input device;
determining device information related to the input device;
determining template information based on the device information; and
performing authentication of the user based on the fingerprint information and based on the template information.
